(19) United States
(12) Patent Application Publication
(10) Pub. No.: US 2007/0014896 A1
(43) Pub. Date: Jan. 18, 2007

(54) Calcium containing soy protein isolate composition

(76) Inventors: Theodore M. Wong, Ballwin, MO (US); Daniel W. Brown, St. Louis, MO (US); Traci R. Hamersen, Webster Groves, MO (US); Ann Grev, St. Louis, MO (US)

Correspondence Address: SOLAE, LLC, PO BOX 88940, ST LOUIS, MO, 63188, US

(21) Appl. No.: 11/183,728

(22) Filed: Jul. 18, 2005

(51) Int. Cl. A23L 1/30

(52) U.S. Cl. 426/74

(57) ABSTRACT

The present invention is directed to a calcium containing vegetable protein containing composition, comprising; a calcium containing protein material containing at least 90% protein by weight, dry basis, said protein material having a dry basis degree of hydrolysis of from about 1.8% up to about 4.0%, a dry basis calcium content of from 0.10% up to about 0.6%, a dry basis density of from about 0.28 up to about 0.48 g/cc, a pH of from about 6.9 up to about 7.7, and a particle size wherein not more than 10% of the particles are retained on a 30 mesh screen. The present invention is also directed to a calcium containing vegetable protein based beverage composition, comprising; a liquid and a calcium containing hydrolyzed soy protein isolate containing at least 90% protein by weight, dry basis, said protein material having a degree of hydrolysis of from about 1.8% up to about 4.0%, a percent calcium of from about 0.15 up to about 0.60, a density of from about 0.15 up to about 0.48 grams per cubic centimeter, a pH of from about 6.9 up to about 7.7, and a particle size wherein not more than 10% of the particles are retained on a 30 mesh screen

### FIELD OF THE INVENTION

This invention relates generally to the incorporation of calcium into protein compositions to produce a dry powder of a calcium containing protein composition that can be reconstituted in water or other media to produce a protein suspension having calcium incorporated into the suspension.

### BACKGROUND OF THE INVENTION

It has been widely accepted that calcium is an essential element for formation of bone and teeth in animals, including humans. In fact, though calcium is the most abundant mineral in the body, approximately 99% of the body's calcium is found in the bones and teeth providing an exchangeable pool of calcium. The remaining one percent is widely distributed in cells and body fluids and is responsible for the regulation of a number of metabolic functions such as nerve impulse conduction, muscle fiber contraction, hormone secretion, blood coagulation, normal heart beat, activation of enzymes, and maintenance of cell membranes. Additionally, calcium is receiving much attention on the front line of medical science because it has recently been discovered that calcium is one of the most important elements for supporting many life activities. For example, recent observations indicate that calcium deficiency not only induces osteoporosis, but also contributes to such diseases as hypertension, arteriosclerosis, arthritis, diabetes, immunological diseases, colon cancer, and obesity. Therefore, the presence of sufficient amounts of calcium within the body is essential for proper health.

One of the problems associated with calcium supplementation is that all sources of calcium are not equally soluble or bioavailable. In addition, some calcium sources are not as pure as others. For example, calcium carbonate derived from bone meal, oyster shell, or other biological origin contains trace amounts of lead and other minerals. Some calcium carbonates also contain silica. Therefore, it is necessary to take additional amounts of these materials to achieve the same bioavailable calcium level as those taken from synthetic sources of essentially pure calcium. In fact, foods fortified with calcium and calcium supplements are being used more often by U.S. consumers and are generally considered by some researchers to offer the same net effect as calcium found naturally in food.

The most effective order of relative bioavailability or intestinal absorption of various calcium salts is controversial. Nevertheless, there are several known factors that affect the absorption of calcium by the human body. In healthy adults, approximately 30% of calcium contained in their diets is absorbed. However, the absorption of calcium from various foods may range from 10% to 40%. Generally, at higher intakes, the efficiency of the absorption process decreases. This is probably due to the body's ability to control the absorption process based upon the need or lack of need for calcium. However, there are methods of altering the body's control over calcium uptake. For example, vitamin D is known to accelerate the intestinal absorption of calcium.

Many forms of ingested calcium are water insoluble and require specific enzymes for proper digestion. These enzymes extract calcium from food and transport it into the blood stream. However, these transport enzymes are not 100% efficient. This means that the transfer of calcium into the blood stream is an amount that is less than the total ingested inorganic calcium. Additionally, acid solutions enhance the solubility of calcium salts. Indeed, the calcium salts in common vitamins are more soluble under acidic conditions. Much of the digestion of foods takes place in the duodenum where the pH of the gastric juices is low. Since calcium salts are more soluble in an acid pH, much of the absorption takes place in this segment of the gastrointestinal tract.

Calcium is a beneficial component of animal nutrition. In human nutrition, it is necessary that calcium be a part of the diet from birth to death. From birth to young adulthood, the calcium consumed as part of the diet is utilized for bone growth, bone density, tooth enamel, and a number of important cellular activities. For the teenage years through mature adulthood, calcium is used to maintain bone density and avoid osteoporosis. Maintenance of a routine, daily intake of bioavailable calcium also contributes to low blood pressure and reducing the incidence of kidney stones.

All of the published nutritional guidelines recommend daily consumption of foods containing calcium. Recommendations vary according to the age, size, and sex of an individual with the average intake for an adult recommended to be approximately 1,000 mg of calcium per day, see U.S. Code of Federal Regulations 101.9(c)(8)(iv). A recent review sponsored by the National Institute of Health stated, “The preferred source of calcium is through calcium-rich foods such as dairy products. Calcium-fortified foods and calcium supplements are other means by which optimal calcium intake can be reached in those who cannot meet this need by ingesting conventional foods.” See Nutrition (1995) pages 409-417.

Calcium supplements are, in general, calcium salts that are either soluble or insoluble in water. The soluble calcium salts (for instance calcium chloride, calcium lactate, calcium malate, and, to some extent, calcium citrate) form relatively clear solutions when dissolved in water and have a high calcium activity. Because of the high calcium reactivity of the soluble salts, they may cause undesirable effects in processed foods, such as aggregation, coagulation, and flocculation of protein components. The insoluble calcium salts, calcium carbonate and calcium phosphate, have low calcium reactivities and do not have undesirable reactions with other processed food components. However, insoluble calcium salts have a chalky or gritty texture and they separate out of food formulations instead of remaining homogeneously dispersed in the food.

A variety of proteins are used in formulating and producing processed foods. The proteins are used for two main reasons. First, they are used to provide desirable functional or sensory characteristics, and these include: emulsion stability, texture, appearance, mouthfeel, flavor, and physical stability during production, storage, and preparation for consumption. Second, proteins may be included in processed food formulations for nutritional purposes. That is, approximately 50 grams of high quality dietary protein should be consumed daily as part of a balanced diet.

Foods that are high in protein are used by ingredient processors to prepare protein concentrates and protein isolates. These protein-containing ingredients may be from 25 to 95% protein, on a dry basis, and they may, for instance, be in the form of: milk and dried milk, milk protein concentrates and dried milk concentrates, milk protein fractions such as casein and whey, soy protein concentrates and soy isolates, egg albumin, meat and plasma extracts or concentrates, nut flour and protein concentrates derived therefrom, fish and fish protein concentrates, and a number of others. Aside from milk, most of these protein sources are not good calcium sources.

Some proteins can be isolated from foods by precipitating the proteins with an acid treatment. The preparation of soy protein isolates and the preparation of milk proteins, especially casein, typify this kind of isolation technique. The proteins are precipitated at or near the isoelectric point of the protein, usually around pH 4.5. These acid precipitates are washed to remove oils, carbohydrates, and other soluble materials and then they are either dried or they can be neutralized with a variety of food grade alkaline agents in order to produce highly functional food ingredients. If the alkaline agent used is calcium hydroxide, Ca(OH)₂, then a calcium caseinate or a calcium soy isolate, for example, can be produced. These neutralized calcium-containing proteins are also good sources of bioavailable calcium, but there is a limit to the amount of calcium that can be provided per gram of protein, with this limit dictated by the acid treatment and the buffering capacity of the acidic protein produced as a precipitate.

It would be highly desirable that ingredient producers be able to supply proteins which retain their well understood characteristics, but which also contain a high level of calcium suitable for providing supplemental calcium in the form of a stable and homogeneous suspension.

### SUMMARY OF THE INVENTION

The present invention is directed to a calcium containing vegetable protein containing composition, comprising;

a calcium containing protein material containing at least 90% protein by weight, dry basis, said calcium containing protein material having a dry basis degree of hydrolysis of from about 1.8% up to about 4.0%, a dry basis calcium content of from 0.10% up to about 0.6%, a dry basis density of from about 0.28 up to about 0.48 g/cc, a pH of from about 6.9 up to about 7.7, and a particle size wherein not more than 10% of the particles are retained on a 30 mesh screen.

In another embodiment, the present invention provides a calcium containing soy protein isolate having excellent functionality and presenting a bland taste. The calcium containing soy protein isolate is suitable for use in a number of foods and drink products. In one embodiment, the calcium containing soy protein isolate has very low levels of numerous volatile compounds known to cause off-flavors in soy protein isolates and products derived therefrom. Specifically, the calcium containing soy protein isolate has very low levels of 3-methylbutanal, pentanal, hexanal, 1-octen-3-ol, 2-pentylfuran, (E) 3-octen-2-one, and (E) 2-octenal. Further, the calcium containing hydrolyzed soy protein isolate contains at least 90% protein by weight, dry basis, said protein material has a dry basis degree of hydrolysis of from about 1.8% up to about 4.0%, a dry basis calcium content of from 0.10% up to about 0.6%, a dry basis density of from about 0.28 up to about 0.48 g/cc, a pH of from about 6.9 up to about 7.7, and a particle size wherein not more than 10% of the particles are retained on a 30 mesh screen.

In another embodiment, the present invention provides a calcium containing soy protein based dry blend composition, comprising;

a calcium containing hydrolyzed protein material containing at least 90% protein by weight, dry basis, said protein material having a dry basis degree of hydrolysis of from about 1.8% up to about 4.0%, a dry basis calcium content of from 0.10% up to about 0.6%, a dry basis density of from about 0.28 up to about 0.48 g/cc, a pH of from about 6.9 up to about 7.7, and a particle size wherein not more than 10% of the particles are retained on a 30 mesh screen,

at least one sweetener; and

at least one flavor enhancer.

### BRIEF DESCRIPTION OF THE DRAWING

FIG. 1 is a representation of a suitable headspace apparatus for use in Gas-Chromatography-Mass Spectrometry analysis as described herein.

### DETAILED DESCRIPTION OF THE INVENTION

The protein material of the present invention may be any calcium containing vegetable or animal protein containing at least 90% protein by weight, dry basis, and having a dry basis degree of hydrolysis of from about 1.8% up to about 4.0%, a dry basis calcium content of from 0.10% up to about 0.6%, a dry basis density of from about 0.28 up to about 0.48 g/cc, and a particle size wherein not more than 10% of the particles are retained on a 30 mesh screen; that when blended into a liquid has a pH of from about 6 to about 8. Preferred protein materials useful in the composition of the present invention include soy protein materials, casein or caseinates, corn protein materials—particularly zein, and wheat gluten. Preferred proteins also include dairy whey protein (especially sweet dairy whey protein), and non-dairy-whey proteins such as bovine serum albumin, egg white albumin, and vegetable whey proteins (i.e., non-dairy whey protein) such as soy protein.

The present invention is generally directed to calcium containing soy protein isolates having excellent functionality in various foods and drink products and presenting a bland taste and processes for producing such soy protein isolates. The calcium containing soy protein isolates have a reduced amount of various volatile compounds known to cause off-flavors in soy protein isolates, which can negatively affect the taste properties of soy proteins.

The calcium containing bland-tasting soy protein isolates described herein are particularly suitable for use with a number of foods and drink products that commonly include soy products therein. For example, the calcium containing soy protein isolates described herein can be suitably used in dry blended beverages, ready to drink beverages that are of neutral or acidic pH, yogurt, dairy products, breads, food and protein bars, cereal products, soups, gravies, infant formula, emulsified meat products, whole muscle meat products, ground meat products, other meat products such as beef, pork, poultry, seafood, meat analogs, and the like. The soy protein isolates may be included in any one of the foods or drink products noted herein, as well as others known in the art, in their commercially established satisfactory amounts.

The calcium containing bland-tasting soy protein isolates of the present invention may be derived from suitable starting materials as described herein that have been produced from any number of commercially available soybeans. For example, the soybeans used to produce the starting materials described herein may be commoditized soybeans, non-commoditized soybeans, high sucrose, (HS) soybeans, genetically modified soybeans, non-genetically modified soybeans identity preserved, and/or hybrid soybeans. For example, the soybeans used to make the starting materials described herein could be soybeans known as high beta-conglycinin soybeans, high glycinin soybeans, low linolenic soybeans or high oleic soybeans.

The protein material used in the present invention, is functionalized (modified) to enhance the characteristics of the protein material, especially improved flavor and food functionalities. The modification of choice is hydrolysis of the protein material, although the addition of calcium also is considered to functionalize protein.

During protein hydrolysis, the peptide bonds of the protein are cleaved under the uptake of water as shown in the below equation. By the cleavage of one equivalent peptide bond, one equivalent of the alpha-carboxy groups as well as of the alpha-amino groups are formed.

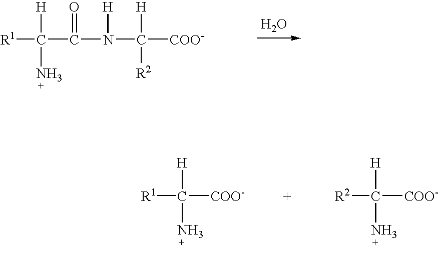

Hydrolysis of the protein material is effected by treating the protein material with an enzyme capable of hydrolyzing the protein with a certain specificity. Many enzymes are known in the art which hydrolyze protein materials, including, but not limited to, mammalian enzymes of pepsin, trypsin, chymotrypsin, and rennet; fungal enzymes of Aspergillus oryzae, and Aspergillus niger; bacterial enzymes of Bacillus amyloliquefaciens, Bacillus licheniforms and Bacillus subtilis; and plant enzymes of bromelain, ficin and papain. A preferred enzyme is bromelain of which one source is the stems of pineapples. Enzyme hydrolysis is effected by adding a sufficient amount of enzyme to an aqueous dispersion of protein material, typically from about 0.1% to about 10% enzyme by weight of the protein material, and treating the enzyme and protein dispersion at a temperature, typically from about 5° C. to about 75° C., and preferably from about 54° C. to about 65° C. and a pH, typically from about 3 to about 9, and preferably from about 6 to about 8 at which the enzyme is active for a period of time sufficient to hydrolyze the protein material. After sufficient hydrolysis has occurred the enzyme is deactivated by heating up to about 140° C. for about 10 minutes.

The present invention is further directed to a calcium containing soy protein isolate comprising less than about 0.5 ppb 3-methylbutanal.

The present invention is further directed to a calcium containing soy protein isolate comprising less than about 10 ppb pentanal.

The present invention is further directed to a calcium containing soy protein isolate comprising less than about 1 ppb (E) 3-octen-2-one.

The present invention is further directed to a calcium containing soy protein isolate comprising less than about 0.2 ppb (E) 2-octenal.

The present invention is further directed to a calcium containing soy protein isolate comprising less than about 40 ppb hexanal.

The present invention is further directed to a calcium containing soy protein isolate comprising less than about 1 ppb 1-octen-3-ol.

The present invention is further directed to a calcium containing soy protein isolate comprising less than 1 ppb 2-pentylfuran.

The amount of enzyme used (enzyme activity) is expressed as tyrosine units (TU) per gram protein curd solids per hydrolysis. Preferably the enzyme activity is from about 1500 to about 3000 TU per gram protein curd solids per hydrolysis and most preferably from about 2000 to about 2500 TU per gram protein curd solids per hydrolysis.

The degree of hydrolysis (commonly expressed as “% DH”) refers to the ratio of the number of peptide bonds cleaved to the total number of peptide bonds originally in the protein chain. Quantitative determination of the cleaved peptide bonds can employ the reaction of trinitrobenzenesulfonic acid, hereinafter referred to as “TNBS,” with primary amines to produce a chromophore that absorbs light at 420 nm. The intensity of color developed in the TNBS-amine reaction is proportional to the number of amino terminal groups created by the hydrolysis of peptide bonds in the protein. The total number of peptide bonds originally in the protein is calculated on a theoretical basis from the amino acid composition of said protein. The total number of peptide bonds in ISP is 885 per 100 kg.

The % DH may be calculated as follows:
% DH=(Peptide Bonds Cleaved)/(Total Peptide Bonds) times 100,
and practically as follows:
   % DH=[(S-B)/885] times 100,
      where “S” equals the number of moles of primary amine detected with TNBS in 100 kg of hydrolyzed ISP and “B” equals the number of moles of primary amine detected with TNBS in 100 kg of unhydrolyzed ISP, both “S” and “B” being expressed on a 100% protein basis calculated using the conversion factor of 6.25. If the value “B” is not analytically determined, a value of 24 can be used as the average number of moles of primary amine in 100 kg of unhydrolyzed ISP.

“S” equals the number of moles of primary amine detected with TNBS in 100 kg of hydrolyzed ISP and “B” equals the number of moles of primary amine detected with TNBS in 100 kg of unhydrolyzed ISP

In the present invention “S” is generally from about 40 to about 60, preferably from about 45 to about 55.

A preferred DH in the present invention is from about 1.8% up to about 4.0%, and most preferably from about 2.3% up to about 3.5%.

The protein material is hydrolyzed at least two times. The same enzyme may be employed for multi-hydrolyses, or the enzymes my be different. After the first hydrolysis and before the second hydrolysis, the contents of protein material, water and enzyme are subjected to a high temperature short time (HTST) treatment in order to render the enzyme inactive. Without wishing to be bound by theory, it is believed that multi-hydrolyses of a protein better utilizes the enzyme in order to obtain a DH of between about 1.8% and about 4.0%. That is, it is believed that a double enzyme hydrolyses employs a total enzyme content that is less than the enzyme content of a single enzyme hydrolysis.

The soy protein isolate is prepared by two different routes, but nevertheless, is typically produced from a starting material, such as defatted soybean material, in which the oil is extracted to leave soybean meal or flakes. More specifically, the soybeans may be initially crushed or ground and then passed through a conventional oil expeller. It is preferable, however, to remove the oil contained in the soybeans by solvent extraction with aliphatic hydrocarbons, such as hexane or azeotropes thereof, and these represent conventional techniques employed for the removal of oil. In the first route, the defatted soy protein material or soybean flakes are placed in an aqueous bath to provide a mixture having a pH of at least about 6.5 and preferably between about 7.0 and 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the protein. Typically, the pH of the aqueous extract of protein will be at least about 6.5 and preferably about 7.0 to 10.0. The ratio by weight of the aqueous extractant to the vegetable protein material is usually between about 20 to 1 and preferably a ratio of about 10 to 1. In an alternative embodiment, the vegetable protein is extracted from the milled, defatted flakes with water, that is, without a pH adjustment.

It is also desirable in obtaining the calcium containing soy protein isolate that an elevated temperature be employed during the aqueous extraction step, either with or without a pH adjustment, to facilitate solubilization of the protein, although ambient temperatures are equally satisfactory if desired. The extraction temperatures which may be employed can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the extracts to, at or near the isoelectric point of the protein to form an insoluble curd precipitate. The actual pH to which the protein extracts are adjusted will vary depending upon the vegetable protein material employed but insofar as soy protein, this typically is between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The soy protein precipitates from the acidified extract, and is then separated from the extract. The separated protein is washed with water to remove residual soluble carbohydrates and ash from the protein material and then solubilized to a slurry by the addition of a basic reagent such as aqueous sodium hydroxide or aqueous potassium hydroxide to a pH of between about 6-8 to prepare a neutralized slurry by the first route.

In the second route, a soy protein concentrate prepared by aqueous ethanol extraction is hydrated with water to produce a suitable dispersion. A suitable soy protein concentrate prepared by aqueous ethanol extraction for use as a starting material in the processes of the present invention can be obtained by processing a soy protein source, such as soy flakes, by an extraction process using aqueous alcohol. Extraction processes for forming soy protein concentrates are well known and disclosed, for example, in U.S. Pat. No. 6,187,367, issued to Cho, et al. (Feb. 13, 2001) and U.S. Pat. No. 6,132,795, issued to Holbrook, et al. (Oct. 17, 2000).

One extraction process suitable for preparing a dry soy protein concentrate for use herein includes obtaining a defatted soy flake material using the method discussed herein above. The defatted soy flake material may then be put through a solvent extraction process. Typically, the solvent for the extraction process is an aqueous alcohol. The aqueous alcohol extraction removes materials soluble therein to produce a protein concentrate material that contains from about 65% to about 85% protein by weight on a dry basis.

Alcohol extraction to remove alcohol soluble components from the protein is particularly preferred in the solvent extraction process since alcohol extraction generally produces a better tasting soy protein material compared to aqueous acid extraction. This type of extraction is based on the ability of the aqueous solvent solutions to extract the soluble sugar/carbohydrate fraction of the defatted soy flake without solubilizing its proteins. A suitable alcohol solvent is an aqueous solution of lower aliphatic alcohols, such as, methanol, ethanol, and isopropyl alcohol.

The aqueous alcohol typically used in this invention is a neutral pH solution, that is, a solution having a pH less than 8.5 and more than about 6.0. Suitably, the aqueous alcohol extraction is conducted at a pH of from about 6.5 to about 7.5.

Typically, the alcohol should be a food grade reagent, and preferably is an aqueous ethanol solution. An aqueous ethanol solution may contain from about 55% to about 95% ethanol by volume. The defatted soy flake material should be contacted with sufficient solution to form a soy protein concentrate containing between about 65% and about 85% protein, by dry weight. Additionally, the resulting soy protein concentrate has a pH of about 7.0. The weight ratio of aqueous ethanol solution to defatted soy flake material may be from about 2:1 to about 20:1, and preferably is from about 5:1 to about 10:1. Preferably, the defatted soy flake material is extracted with the aqueous ethanol solution to facilitate removal of materials soluble in the aqueous ethanol solution from the defatted soy flake material. The aqueous ethanol solution is recirculated through the extractor until the residual carbohydrate and isoflavone content in the defatted soy flakes is reduced to the desired level. The above described aqueous alcohol extraction removes alcohol soluble components of the defatted soy flakes. The soy protein concentrates obtained from the extraction process can then be desolventized into a dry soy protein concentrate.

The soy protein concentrate prepared by aqueous ethanol extraction starting material is hydrated with water that is typically heated to facilitate the hydration to produce a dispersion. The water may be heated from about 25° C. to about 35° C., for example, to assist in the hydration. Additionally, mixing utilizing standard mixing techniques known in the art may be utilized to further hydration. The soy protein concentrate prepared by aqueous ethanol extraction is typically introduced into the water at a weight ratio of water to soy protein concentrate of from about 5:1 to about 30:1 and suitably from about 10:1 to about 20:1. Without being bound to a particular theory, it is believed that the ratio of water to starting material affects the isoflavone content of the final product. Higher ratios of water to starting material yields lower isoflavone content of the final product. Further, increasing the ratio of water to starting material increases final product yield.

After the hydration of the soy protein concentrate prepared by aqueous ethanol extraction is complete and the dispersion formed, the dispersion is heated to a temperature of at least about 125° C. for a time period of from about 5 seconds to about 30 seconds, suitably for about 9 seconds, to form a slurry. A preferred temperature to heat the dispersion to and hold it for the appropriate time is from about 145° C. to about 155° C., and suitably about 150° C. The dispersion may be heated by any means known in the art including, for example, by using a steam treatment, such as a direct steam treatment. The dispersion is heated and held at the elevated temperature in this step to solubilize the soy proteins present in the starting material soy protein concentrate because the soy proteins present in the starting material soy protein concentrate are primarily insoluble in water due to denaturation of the soy protein caused by the aqueous ethanol extraction used to produce the starting material. It has been found that heat treatment of the dispersion at this point in the calcium containing soy protein isolate manufacturing process solubilizes the soy proteins in the starting material in water thus enabling separation of soy proteins and other soluble components from fiber in subsequent processing steps.

Once the slurry has been formed, it may optionally be flash cooled prior to additional processing. Flash cooling provides several potential benefits including (1) cooling the slurry so as to not heat denature the resolubilized proteins in the slurry; (2) removing water from the steam addition with vapor flashing; and (3) potentially removing off-flavor volatiles with vapor flashing. In a suitable embodiment, the flash cooling is performed by flashing under a vacuum. Alternatively, the slurry may be flash cooled at atmospheric pressure. Generally, the slurry is flash cooled to a temperature of from about 35° C. to about 85° C. using a vacuum pump, a condenser, and a tank rated for negative atmospheric conditions.

Optionally, the slurry, regardless of whether it has been flash cooled or not, may be pH adjusted prior to further processing as described below. In one embodiment, the slurry is pH adjusted to a pH of from about 8 to about 10, suitably from about 9 to about 10, more suitably from about 9.5 to about 9.7, and still more suitably about 9.7. The pH adjustment can be made with any suitable base such as, for example, sodium hydroxide. The pH adjustment may improve the overall yield of the process by allowing more protein to be extracted in the process.

After the heating, flash cooling, and pH adjustment, the slurry is separated to produce a supernatant for further processing (containing the soluble soy proteins) and a centrifuge cake (containing insoluble fiber) that is ultimately discarded. The separation may be done in a single step using a decanter centrifuge, for example, or may be done in two or more steps to improve overall soy protein yield. For example, in one embodiment, the separation comprises two separation steps, each of which utilizes a decanter centrifuge or similar centrifuge. In the first step, the slurry is centrifuged to produce a first supernatant and a first centrifuge cake. The first centrifuge cake is then diluted with water, typically at a temperature of about 30° C. to about 85° C., at a dilution weight ratio of, for example, 6:1 water to starting material, and centrifuged a second time to produce a second centrifuge cake and a second supernatant. The first and second supernatants, which contain the soy proteins, are combined for further processing and the second centrifuge cake is discarded.

Once the supernatant has been produced, it may optionally be further clarified to remove any remaining fine insoluble particles that may remain in the supernatant. In one embodiment, a disc centrifuge can be used for the clarification. Typically, the supernatant will be at a temperature of from about 35° C. to about 85° C. during the clarification. The clarification results in more purified soy protein isolates.

The pH of the supernatant is then adjusted to a pH of from about 4.2 to about 5.2, suitably about 4.5 to separate the insoluble protein from the undesirable components in subsequently described process steps. Any number of conventional acids such as hydrochloric acid, sulfuric acid, phosphoric acid, acetic acid, lactic acid and the like can be used for the separation. Both organic and inorganic acids are suitable for adjusting the pH of the supernatant. Generally, the pH of the supernatant is adjusted during the continuous mixing of the supernatant. Mixing may be performed by any standard equipment known in the art, such as, for example, mechanical agitators.

The formed precipitate is then separated from the undesirable components and washed with water to remove undesirable components from the precipitate. A weight ratio of water to starting material of about 2:1 can be used to wash the precipitate material while it is being separated in a disc centrifuge, for example. A single wash can be done, or multiple washes can be done to thoroughly wash the precipitate and remove undesirable components such as carbohydrates, minerals, and volatiles.

Once the precipitate is separated, it can optionally be hydrated with water to form a hydrated precipitate slurry. The water is typically added at a water to starting material weight ratio of about 5:1 to add enough fresh water into the system to further clean out any remaining undesirable components such as carbohydrates, minerals, and volatiles in the precipitate.

Prior to the hydrated precipitate slurry being separated it can optionally be heated to a temperature of from about 50° C. to about 85° C., suitably about 57° C. for a time period of from about 1 second to about 2 minutes, suitably from about 5 seconds to about 1 minute, and more suitably from about 5 seconds to about 30 seconds. This heating increases the solubility in the water of any remaining undesirable components and assists in their removal downstream.

Additionally, the hydrated precipitate slurry may optionally then be separated in a centrifuge, such as a decanter centrifuge to produce a concentrated cake, which is used for further processing, and a supernatant, which contains the undesirable components, that is discarded. The concentrated cake may then optionally be diluted with water to an appropriate percent solids, such as about 12% to about 15% for further processing. The precise amount of percent solids is not narrowly critical, so long as the amount of solids does not rise to the level where viscosity increases to a point where processing is affected.

The pH of the hydrated precipitate slurry is then adjusted to a pH of from about 6.5 to about 8, suitably from about 7 to about 8, and more suitably about 7.4 to form a neutralized slurry by the second route. The pH adjust of the hydrated precipitate slurry re-solubilizes the protein in the hydrated precipitate slurry.

The neutralized slurry of soy protein prepared by either the first route or the second route is then hydrolyzed. The neutralized slurry is subjected to a first hydrolysis at a temperature of between about 20° C. and 45° C. by the addition of a plant enzyme to form low molecular weight amino acids. After about 30 minutes, calcium hydroxide is added as a water slurry to react with the amino acids to form calcium amino acids. After a brief reaction time, the plant enzyme is rendered inactive by pasteurizing the slurry. The slurry produced is pasteurized to ensure that the enzyme is destroyed and that microbial activity is minimized. The slurry commonly is pasteurized by subjecting the slurry to a (HTST) treatment. The HTST treatment can be carried out by pumping the slurry through a steam injector where the protein containing slurry is mixed with live steam and is heated rapidly to between about 130° C. and about 150° C.. The heated protein containing slurry is then passed through a hold tube, under pressure, for a relatively short period of time, e.g., 5 to 10 seconds. After the hold tube, the heated protein containing slurry is cooled by passage into to a vacuum vessel. The evaporation of water from the heated protein containing slurry under vacuum results in flash cooling of the heated slurry, allowing the temperature to be rapidly dropped to the range of 50° C. and 85° C.. This type of treatment has been found to be very effective at destroying bacteria while avoiding substantial chemical degradation of the protein.

If necessary, the pH of the slurry is adjusted to between about 6-8 with aqueous sodium hydroxide. The slurry is then subjected to another cycle of hydrolysis, pasteurization and flash cooling. The slurry is then homogenized at about 2500 pounds per square inch and then subjected to spray drying. The slurry is spray dried wherein the inlet temperature of the spray dryer is from about 250° C. to about 345° C. and the outlet temperature is from about 70° C. to about 90° C. The dried contents are subjected to a grinding step to provide the protein isolate of the present invention. The grinding is performed such that not more than 10% of the dried finished product is retained on a 30 mesh screen. Lecithin is added in the amount of 0.1-1.0% to aid in the suppression of dust in the finished product.

The soy protein isolate contains from about 0.1% up to about 0.6% calcium such that the isolate has an increase functionality and an increased density. Further, it is necessary to grind the spray dried soy protein isolate to a size such that when a beverage is prepared, the isolate will stay suspended for a longer period of time within the beverage. Non-ground, and thus larger particle size soy protein isolates tend to separate from the beverage to form a sediment rather quickly.

In addition to the above, the calcium containing soy protein isolates produced in accordance with the present invention have very low levels of various volatile compounds. As previously noted, various volatile compounds can result in calcium containing soy protein isolates having undesirable off-flavors. Specifically, the calcium containing soy protein isolates have very low levels of at least one, or at least two, or at least three, or at least four, or at least five, or at least six, or even all seven of the following volatile compounds: (1) 3-methylbutanal; (2) pentanal; (3) hexanal; (4) 1-octen-3-ol; (5) 2-pentylfuran; (6) (E) 3-octen-2-one; and (7) (E) 2-octenal.

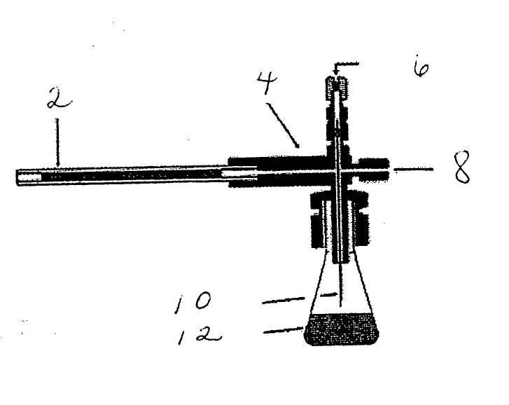

The amount of these volatiles in the calcium containing soy protein isolates produced in accordance with the present invention can be measured using Dynamic Headspace (DHS) sampling with Gas-Chromatography-Mass Spectrometry (GC-MS) analysis. Specifically, GC-MS headspace analysis is an objective method for determining volatile constituents produced by the calcium containing soy protein isolate by analyzing the vapor phase. A suitable headspace apparatus is shown in FIG. 1, and includes a desorption tube 2, a purge head 4, sparge gas inlet 6, dry purge gas inlet 8, sparge needle 10, and sample 12.

The temperature control of the sample 12 being analyzed in the headspace apparatus is maintained by the use of water jacketing. A 45° C. circulating water bath is connected via tygon tubing to a jacketed beaker large enough to hold the sample vessel, a 50-milliliter Erlenmeyer flask with a 24/40 ground glass joint (Kontes part 617000-0124). The jacketed beaker, containing water, sits on a digitally controlled stir plate with a built-in-timer (VWR Model 565 part 14217-602). A teflon purge head adapter (Scientific Instrument Services (SIS) part 164372) is fit to the Erlenmeyer flask, with a tube style purge head (SIS part 783009) fitted to the adapter. The purge head 4 also contains a sparging needle 10 adjusted such that the tip is 3 plus or minus 1 millimeter above the sample slurry meniscus and directs nitrogen extracting gas (99.9999% pure) toward the surface of the sample 12. Nitrogen gas is obtained from the 60 psig house GC manifold system via a toggle valve and step-down regulator set at 20 psig. A tee coupling directs gas to two digital mass flow controllers (Aalborg part GFC 171). The desorption tube 2 is attached to the purge head during sample collection.

To use GC-MS headspace analysis for an isolate, 5 grams plus or minus 0.005 grams of a soy protein isolate sample to be analyzed is weighed in a weigh boat. Ninety-five milliliters plus or minus 0.1 milliliters of reverse-osmosis water, available as Milli-Q from Millipore (Billerica, Mass.), is then measured into a graduated cylinder. The water is then transferred into a small (250 milliliters) Waring blender cup. The soy protein isolate sample is added into the blender. The sample and water are blended at a minimum blending speed for a period of about 1 minute to achieve a good dispersion. The sample slurry is then transferred from the blender cup into an amber bottle. The amber bottle is sealed with a teflon lined screw cap and stored for a period of from about 14 hours to about 30 hours under refrigeration (35° F.-40° F.) to allow the volatiles to establish equilibrium between the soy protein, the aqueous phase, and the headspace. Prior to analysis, the sample bottle is warmed to room temperature by room equilibration or with warm water and stirring.

An internal standard solution is prepared from 4-heptanone (density 0.817 g/ml), available from Aldrich Chemical Co. (St. Louis, Mo.). To prepare the internal standard stock solution, 10.0 microliters of 4-heptanone is first added to reverse osmosis water in a 100-milliliter volumetric flask using a 10-microliter gas tight syringe. The flask is then made to volume the reverse osmosis water. Twelve milliliters of this solution is then added to a 100-milliliter flask which is made to volume with reverse osmosis water to obtain the internal standard stock solution. To a 20.0 gram sample of soy protein slurry, is added 0.10 milliliters of the internal standard stock solution to obtain a concentration of 49 ppb 4-heptanone.

After the calcium containing soy protein slurry and internal standard solution are prepared, a sample extraction of the slurry is conducted. To extract the sample, a clean sample collection tube is attached (4 mm i.d. silco-treated stainless steel desorption tube, available as part 786002 from Scientific Instrument Services (SIS) (Ringoes, N.J., packed with 280 milligrams of 60/80 mesh Tenax-GR sorbent (SIS part 979401), held in place at each end with a small plug of silanized glass wool (Supelco part 2-0411))) to a headspace apparatus. Then, an octagonal stir bar (1×⅜″) is added to a 50-milliliter Erlenmeyer flask and 20.00 grams plus or minus 0.02 grams of sample slurry, which has been warmed to room temperature, is added into the flask. Additionally, 7.5 grams plus or minus 0.1 grams of analytical grade sodium chloride is added to the flask. So as not to create foam or wet flask sides or neck joint, the slurry is transferred with a pipette and the stir bar mixer is not activated at this time. 0.10 milliliters of the internal standard solution is then pipetted into the flask.

Immediately after adding the internal standard solution, a purge head 4 is placed firmly onto the Erlenmeyer flask to minimize any escape of the sample volatiles. The tip of the sparging needle 10 should be 3 plus or minus 1 millimeter above the sample slurry meniscus. The entire assembly is then placed into a water filled jacketed beaker, clamped in place, and attached to the two nitrogen line fittings. Without waiting for any temperature equilibration, the nitrogen line toggle valve is opened to start the extraction by firmly holding the purge head assemble in the Erlenmeyer flask neck joint (to prevent popping out by pressure surge). The stir plate is energized to produce 200 rpm. The top of the jacketed beaker is enclosed with aluminum foil to retain heat. The stirring slurry surface should contain little or no foam to facilitate maximum volatiles migration from liquid into headspace. Extraction is carried out for a period of 45 plus or minus 0.1 minutes using a 50 milliliters/minute nitrogen flow through the sparging needle 10. Simultaneously, diluting nitrogen gas (dry purge gas) passes through the top of the purge head 4 at a flow rate of 51 milliliters/minute to help flush water vapor through the desorption tube 2. After 45 minutes, the desorption tube 2 and cap are unscrewed and held at room temperature for GC-MS analysis.

To begin the GC-MS analysis, the desorption tube needle (SIS part #786035), containing a vespel seal (SIS part #786018), is attached to the sample inlet end of the desorption tube 2 that contains the purged volatiles. To the other end of the desorption tube, the autodesorb connecting tube (SIS part #786009) is attached. The assembly is placed into one of the twelve positions in the SIS Automated Short Path Thermal Desorption Injection System. Before beginning desorption, the desorption conditions are set as follows: purge: 1.00 minute, inject: 1.00 minute, desorb: 5.00 minutes at 280° C., heat delay: 0.5 minutes, start GC: 7.5 minutes, Cryo trap: −150° C., with the liquid nitrogen source attached, Cryo heat: 283° C., and desorb temp: 280° C.. Additionally, the pressures of the gas manifold lines should be set as follows: helium: 60 plus or minus 1 psig and nitrogen: 60 plus or minus 1 psig, with a step-down to 20 psig during sample extraction. The GC-MS analysis is initiated with the ChemStation software that also initiates the SIS desorber system.

GC-MS analysis may be conducted using an Agilent®6890N GC equipped with a 7973 MSD detector and Agilent® ChemStation software Version C.00.00 (Palo Alto, Calif.). Attached to the GC is a Scientific Instrument Services (SIS) AutoDesorb System with SIS controlling software Version 1.0.3. The conditions of the GC apparatus are set as follows: the injector contains SIS injection port liner SIPL 10 and its temperature is 280° C., with helium carrier gas at 1.1 milliliters/minute at split ratio 4.0:1; the column is an Agilent® Ultra 1-50 meters ×0.32 millimeters, with 0.52 microns stationary phase (available as part 19091A-115 from Agilent); and the temperature is set initially at 35° C. and held for 1 minute, then raised 4° C./minute to 180° C., and then again raised 30.0° C./minute to 270° C. and held for 3 minutes. The conditions of the MS apparatus are set as follows: the transfer tube is 280° C.; source is 230° C.; vacuum is max 2×10-5 Torr; mass range is 27-350 a.m.u.; and scan frequency is at 3 Hz.

To analyze the data produced in the GC-MS analysis, the raw peak area obtained by extracted SIM (selected ion monitoring) for the selected target ion was multiplied by a conversion factor. The conversion factors are obtained by dividing the combined abundance of the 10 largest ions in the spectrum of the authentic standard by the abundance of the target ion. The conversion factor for the internal standard peak area is determined with an authentic sample of 4-heptanone run on the mass spectrometer used for these analyses. The conversion factors for the target analytes are calculated from the spectra present in the NIST mass spectral library. The resulting peak area is representative of the total mass spectral response for that compound. This value was divided by the peak area for the internal standard and multiplied by 49, since the internal standard concentration is 49 ppb, to yield the concentration in ppb for the target analyte.

The list of target compounds, with retention time (in minutes), quantitation ion and conversion factor for use in converting the extracted SIM peak area to total ion peak area are shown in Table 1.

TABLE 1

| | Retention | Quantitation | Conversion |
|---|---|---|---|
| Target Compound | Time (min.) | Ion | Factor |
| 3-methylbutanal | 6.2 | 58 | 10.84 |
| pentanal | 7.2 | 44 | 4.14 |
| hexanal | 10.5 | 56 | 5.70 |
| 1-octen-3-ol | 17.7 | 57 | 2.13 |
| 2-pentylfuran | 18.0 | 81 | 1.90 |
| (E) 3-octen-2-one | 19.7 | 111 | 6.30 |
| (E) 2-octenal | 20.4 | 70 | 9.20 |
| 4-heptanone (Internal | 13.5 | 114 | 14.72 |
| Standard) | | | |

In one embodiment of the present invention, the calcium containing soy protein isolate comprises less than about 0.5 ppb 3-methylbutanal, suitably less than about 0.4 ppb 3-methylbutanal, suitably less than about 0.3 ppb 3-methylbutanal, and even more suitably less than about 0.2 ppb 3-methylbutanal.

In another embodiment of the present invention, the calcium containing soy protein isolate comprises less than about 10 ppb pentanal, suitably less than about 8 ppb pentanal, suitably less than about 6 ppb pentanal and even more suitably less than about 4 ppb pentanal.

In another embodiment of the present invention, the calcium containing soy protein isolate comprises less than about 40 ppb hexanal, suitably less than about 20 ppb hexanal, suitably less than about 18 ppb hexanal, and even more suitably less than about 15 ppb hexanal.

In yet another embodiment of the present invention, the calcium containing soy protein isolate comprises less than about 1 ppb 1-octen-3-ol.

In yet another embodiment of the present invention, the calcium containing soy protein isolate comprises less than about 1 ppb 2-pentylfuran, suitably less than about 0.8 ppb 2-pentylfuran, and even more suitably less than about 0.5 ppb 2-pentylfuran.

In yet another embodiment, the calcium containing soy protein isolate comprises less than about 1 ppb (E) 3-octen-2-one and suitably less than about 0.70 ppb (E) 3-octen-2-one.

In still another embodiment, the calcium containing soy protein isolate comprises less than about 0.3 ppb (E) 2-octenal, suitably less than about 0.2 ppb (E) 2-octenal, and even more suitably less than about 0.1 ppb (E) 2-octenal.

The calcium containing soy protein isolates described herein additionally have suitable viscosity properties to allow for their use in a number of food products. As used herein, the term “viscosity” means the apparent viscosity of aqueous slurry or a solution as measured with a rotating spindle viscometer utilizing a large annulus. In one embodiment, the viscosity of the soy protein isolate is measured using a Brookfield viscometer (available as Model LVT from Brookfield Engineering Laboratories, Inc., Middleboro, Me.). Specifically, to determine the viscosity, a sample of the soy protein isolate is dispersed in water at 23° C. to produce a 10% dispersion by weight. The spindle, #3, attached to the Brookfield viscometer, is rotated in the dispersion at a speed of either about 30 revolutions per minute (rpm) or about 60 rpm. Resistance of the dispersion on the spindle is measured by the viscometer in terms of centipoise.

The calcium containing soy protein isolates (10% dispersion by weight in water) have a viscosity of less than about 400 centipoise, suitably less than about 300 centipoise, suitably less than about 200 centipoise, and more suitably less than about 100 centipoise.

The following example illustrates the preparation of the calcium containing hydrolyzed protein of this invention. This example, and examples utilizing the calcium containing hydrolyzed protein in a product of a beverage, are provided to teach those of ordinary skill in the art how to make and use the compositions of this invention. These illustrations are not to be interpreted as specific limitations as to the scope of what the inventors regard as their invention. Efforts have been made to ensure accuracy with respect to numbers used. (e.g., amounts, temperature, etc.). Unless otherwise indicated, temperature is in degrees Celsius.

### EXAMPLE 1

An acid curd slurry is transferred to a tank and adjusted to a 16% ±0.5% solids by the addition of water. The temperature of the slurry is at (35±5)° C.. A 50% aqueous sodium hydroxide solution is added to adjust the contents of the slurry to a neutral pH. Then added is about 0.005 grams calcium hydroxide per gram protein curd solids to achieve an increase in density of the finished protein powder. A bromelain enzyme is added at a level of 0.01±0.005% (2500 TU/g activity) per gram acid curd solids to partially hydrolyze the soy protein and the contents are stirred for about 30 (28±5) minutes. At the end of the hold time, the contents are subjected to a high temperature short time (HTST) procedure of from about 149° C. up to about 155° C. for about 9±1 seconds to inactivate the enzyme. The contents are cooled to between about 50° C. and about 70° C. followed by the addition of 0.026±0.001% (2500 TU/g activity) per gram protein solids of a second portion of a bromelain enzyme and the contents are permitted to mix for about 50-60 (55±2) minutes. Again the contents are subjected to a HTST procedure of about 149° C. up to about 155° C. for about 9±1 seconds to inactivate the enzyme. The contents are permitted to cool to between about 85° C. and about 88° C. and held at this temperature range for about 15±5) minutes. The contents are homogenized at about 2500 pounds per square inch and then subjected to spray drying wherein the inlet temperature of the spray dryer is between about 250° C. and about 340° C. and the outlet temperature is between about 70° C. and about 95° C.. The dry contents are subjected to a grinding step such that not more than 10% is retained on a 30 mesh screen. Lecithin is added in the amount of 0.1-1.0% to aid in the suppression of dust in the finished powder. Analyses: DH 2.9,% calcium 0.32, and density 0.37 g/cc.

The calcium containing hydrolyzed protein isolate of this invention is dry mixed, commonly referred to as dry blended. This dry blend is then combined with a liquid prior to consumption. A calcium containing soy protein based composition, comprising;

The dry blend comprises the calcium containing hydrolyzed soy protein isolate having a degree of hydrolysis of from about 1.8% up to about 4.0%, a percent calcium of from about 0.10 up to about 0.60 and a density of from about 0.15 up to about 0.48 grams per cubic centimeter, at least one sweetener, and at least one flavor enhancer.

The sweeteners are selected from at least one of sucrose, corn syrup, dextrose, high fructose corn syrup, and artificial sweeteners.

The flavor enhancer is selected from sodium chloride and sodium phosphate.

The calcium containing hydrolyzed soy protein isolate is present in the dry blend at from about 45 parts by weight up to about 70 parts by weight; the sweetener is present at from about 30 parts by weight up to about 50 parts by weight; and the flavor enhancer is present at from about 0.1 parts by weight up to about 3 parts by weight. It is to be understood that other components may be added to the above described components to form the dry blend.

The following Example 2 illustrates the preparation of the dry blend containing the calcium containing hydrolyzed protein of this invention. Example 3 is a comparative dry blend that does not contain a calcium containing hydrolyzed soy protein. The protein within Example 3 is a hydrolyzed soy protein identified as Supro® 660 commercially available from Solae, LLC (St. Louis, Mo.).

### EXAMPLE 2

| Component | Parts by Weight | Grams per Serving |
|---|---|---|
| Product of Example 1 | 56.85 | 16.89 |
| Fructose | 20.23 | 6.01 |
| Sucrose | 20.22 | 6.01 |
| Dry Cream Extract | 1.01 | 0.30 |
| Ice Cream Vanilla Flavor | 1.35 | 0.40 |
| Sodium Chloride | 0.34 | 0.10 |
| Total | 100.00 | 29.71 |

### EXAMPLE 3

The procedure of Example 2 is repeated except that the product of Example 1 is replaced with Supro® 660, a non-calcium containing, but hydrolyzed soy protein isolate.

Ready to drink beverages are prepared by adding a dry blend as prepared above to a liquid. The liquid is selected from the group consisting of skim milk and water. Order of addition of is of no importance.

Within the ready to drink beverage, the liquid is present at from about 85% up to about 95% by weight of the total composition, the pH of the ready to drink beverage is from about 6.8 up to about 7.4, and the viscosity is from about 3 centipoise up to about 12 centipoise.

Example 4 is the inventive ready to drink beverage prepared by adding 29.71 grams of the product of Example 2 to 240 ml of skim milk. The contents are blended for 30 seconds.

Example 5, is the inventive ready to drink beverage prepared by adding 29.71 grams of the product of Example 2 to 240 ml of water. The contents are blended for 30 seconds.

Example 6 is the comparative ready to drink beverage prepared by adding 29.71 grams of the product of Example 3 to 240 ml of skim milk. The contents are blended for 30 seconds.

Example 7 is the comparative ready to drink beverage prepared by adding 29.71 grams of the product of Example 3 to 240 ml of water. The contents are blended for 30 seconds.

The acceptability of the ready to drink beverage compositions in the various embodiments of the present invention, includes the organoleptic acceptability, which can be measured, for example by determining the value on a nine-point hedonic scale. A composition is considered, herein, to be organoleptically acceptable if the Appearance, Flavor, and Mouthfeel of the composition each score at least about four or greater on a nine-point hedonic scale.

When determining the overall acceptance rating of a calcium fortified protein-containing product, the product was evaluated by a panel of 70 panelists (males and females, ages 35-54) to provide statistically valid results having a confidence interval of at least 95%. The beverage from a non-calcium containing, but hydrolyzed soy protein isolate is used as a control. The test products are evaluated using blind product paired test. A nine point hedonic scale is used to judge the overall acceptability of the calcium fortified products. Such scale and methodology can be found on pages 101-103 and 213 of Sensory Evaluation Techniques, 2.sup.nd Edition by Morten Meilgaard et al., CRC Press, 1991.

Standard procedures for sensory evaluation are known in the art including, in particular, a 9-point hedonic scale as described below (see Stone and Sidel in Sensory Evaluation Practices, Academic Press, Orlando, 1986, pp 58-86, 227-252). Sensory characteristics that can be tested include Appearance, Flavor, and Mouthfeel. Compositions scoring above neutral on a 9-point hedonic scale, i.e. 5.0 or greater, for at least one, more preferably two an most preferably all sensory characteristics of Appearance, Flavor and Mouthfeel are considered to be acceptable with respect to those attributes.

Experimental samples were evaluated for Flavor and Mouthfeel on a standard nine-point hedonic scale. The scale is as follows:

| Score/rating | Std. Hedonic Scale |
|---|---|
| 9 | Like extremely |
| 8 | Like very much |
| 7 | Like moderately |
| 6 | Like slightly |
| 5 | Neither like nor dislike |
| 4 | Dislike slightly |
| 3 | Dislike moderately |
| 2 | Dislike very much |
| 1 | Dislike extremely |

The below hedonic results are summarized in Table 2, below.

TABLE 2

| Beverage Example | Appearance | Flavor | Mouthfeel |
|---|---|---|---|
| 4 | 5.6 | 5.4 | 4.5 |
| 5 | 4.9 | 4.5 | 4.0 |
| 6 | 5.2 | 4.3 | 3.5 |
| 7 | 3.3 | 3.5 | 3.3 |

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A calcium containing vegetable protein containing composition, comprising;
a calcium containing protein material containing at least 90% protein by weight, dry basis, said protein material having a dry basis degree of hydrolysis of from about 1.8% up to about 4.0%, a dry basis calcium content of from 0.10% up to about 0.6%, a dry basis density of from about 0.28 up to about 0.48 g/cc, a pH of from about 6.9 up to about 7.7, and a particle size wherein not more than 10% of the particles are retained on a 30 mesh screen.

2. The composition of claim 1 where the vegetable protein is a soy protein.

3. The composition of claim 2 further comprising less than about 0.5 ppb 3-methylbutanal.

4. The composition of claim 2 further comprising less than about 10 ppb pentanal.

5. The composition of claim 2 further comprising less than about 20 ppb hexanal.

6. The composition of claim 2 further comprising less than about 1 ppb 1-octen-3-ol.

7. The composition of claim 2 further comprising less than about 1 ppb 2-pentylfuran.

8. The composition of claim 2 further comprising less than 1 ppb (E) 3-octen-2-one.

9. The composition of claim 2 further comprising less than about 0.2 ppb (E) 2-octenal.

10. The composition of claim 2 wherein the degree of hydrolysis of from about 2.3% up to about 4.5%.

11. A calcium containing soy protein based dry blend composition, comprising;
a calcium containing protein material containing at least 90% protein by weight, dry basis, said protein material having a dry basis degree of hydrolysis of from about 1.8% up to about 4.0%, a dry basis calcium content of from 0.10% up to about 0.6%, a dry basis density of from about 0.28 up to about 0.48 g/cc, a pH of from about 6.9 up to about 7.7, and a particle size wherein not more than 10% of the particles are retained on a 30 mesh screen;
at least one sweetener; and
at least one flavor enhancer.

12. The composition of claim 11 wherein the sweeteners are selected from at least one of sucrose, corn syrup, dextrose, high fructose corn syrup, and artificial sweeteners.

13. The composition of claim 12 wherein the flavor enhancer is selected from the group consisting of sodium chloride and sodium phosphate.

14. The composition of claim 13 further comprising a liquid to form a beverage composition.

15. The beverage composition of claim 14 wherein the liquid is selected from the group consisting of skim milk and water.

16. The beverage composition of claim 15 wherein the liquid is present at from about 85% up to about 95% by weight of the total composition.

17. The beverage composition of claim 16 characterized in that at least one of Appearance, Flavor, and Mouthfeel of the beverage composition, score at least about five on a nine-point hedonic scale.

18. The beverage composition of claim 16 wherein the pH is from about 6.8 up to about 7.4.

19. The beverage composition of claim 16 wherein the viscosity is from about 3 centipoise up to about 12 centipoise.
